(19) United States
(12) Patent Application Publication
(10) Pub. No.: US 2009/0077848 A1
(43) Pub. Date: Mar. 26, 2009

(54) Hand operated traffic signal device

(76) Inventor: Grant D. Dicke, Downers Grove, IL (US)

Correspondence Address: Olson & Cepuritis, LTD., 20 NORTH WACKER DRIVE, 36TH FLOOR, CHICAGO, IL, 60606, US

(21) Appl. No.: 11/901,987

(22) Filed: Sep. 20, 2007

(51) Int. Cl. G09F 21/02; E01F 9/00

(52) U.S. Cl. 40/586; 116/63 P

(57) ABSTRACT

A hand-held display device such as a stop/slow paddle is provided for warning passing motorists. Included is a self-supporting sign panel having opposed major surfaces for displaying warning information. A first mast section has a first end receiving the sign panel and an opposed second end. A second mast section is releasably joined to the first mast section with a coupler providing end-to-end joinder, with the coupler keyed to the first and the second mast sections. At least one of the first and the second mast sections have a tactile indication of the angular position of the sign panel.

### FIELD OF THE INVENTION

The present invention relates to the field of traffic signaling devices, and in particular to hand supported paddle signs.

### BACKGROUND OF THE INVENTION

Safety warning equipment such as paddle signs bearing stop and slow designations have been developed using commonly available materials such as PVC water pipe and fittings therefor. While generally economical to construct, these arrangements suffer from a number of drawbacks. For example, it is often desirable to provide warning signs that are either hand held or rest on the ground. In either application, a safety officer, road worker or other operator need only rotate the sign mast to display the desired message to oncoming motorists. It has become popular to display a choice of one of two messages, incorporated on opposing sides of a rigid sign panel, referred to as a paddle. As is well known, an operator stands adjacent to a flow of traffic and at appropriate times rotates the sign to display one of the two messages, usually stop or slow to the motorists.

While this signaling operation can be readily accomplished during ideal weather and relatively light, slow moving traffic conditions, inclement weather and/or fast moving traffic can burden the operator, sometimes to an undesirable point of distraction. Contributing to the problem is the critical need for the operator to send the correct message at a given time. For example, it may be necessary to stop traffic to allow a workman to temporarily access the road surface, and only a command to stop is appropriate. In order to ensure that the proper signal is given, the operator must look away from oncoming traffic to concentrate visual focus on the message being displayed, the mast providing little or no indication of the message being displayed.

As mentioned, it has been found desirable to provide two different types of signs, one having a short handle for being held by hand, and the other having a long mast, to be supported by the ground. While the message panel can be the same for both types of signs, the sign construction is considerably different. Couplers used to secure sections of water pipe together are intended to be permanently adhesively bonded to the pipe sections, thus rendering the resulting sign unsuitable for compact storage. If the couplers are left “dry,” that is, unsecured, the pipe sections are not rendered suitably rigid and stable. Also, further cost savings can be attained if the ground supporting mast is made of one continuous piece, eliminating the need for a coupling joint. Unfortunately, this type of sign is also unsuitable for compact storage. As will be seen, the present invention overcomes these disadvantages.

### SUMMARY OF THE INVENTION

The present invention provides a novel and an improved warning sign that minimizes the disadvantages associated with the prior art signs and provides advantages in construction, mode of operation and use. One embodiment of the invention comprises a hand-held display device for warning passing motorists. Included is a self-supporting sign panel having opposed major surfaces for displaying warning information, and a first mast section with a first end receiving the sign panel for engagement therewith and an opposed second end. A second mast section is joined to the first mast section by a coupler releasably joining the first and the second mast sections end-to-end. The coupler is keyed to the first and the second mast sections, and the first and the second mast sections provide a tactile indication of the angular position of the sign panel. In one example, tactile indication is provided with first and second mast sections having an outer surface with alternating rounded and flattened portions indicative of the angular position of the sign panel.

In another example, the coupler has first and second opposed sockets for receiving ends of the first and the second mast sections. The coupler may be permanently fixed to one mast section and releasably connected to the other mast section. Preferably, the coupler is permanently fixed to the first mast section and releasably connected to the second mast section, and the socket releasably connected to the second mast section has internal splines engaging the second mast section.

The first and the second mast sections and the coupler may be provided with interfitting keying structures to assure their correct assembly, and to ensure consistency throughout a working organization, giving the operators added confidence that the correct message is being displayed to oncoming motorists. In one example, the keying structures of the first and the second mast sections have outwardly protruding structures received in cooperating recesses in the socket. Preferably, the keying structure on at least one of the first and the second mast sections is formed parallel to a longitudinal axis thereof, to provide tactile indication of the angular position of the sign panel. For example, the keying structure may have a generally triangular or a generally rectangular cross-sectional shape. Portions of the keying structure not contained within the recess provide additional tactile indication of sign position. If desired, the coupler includes a recess receiving a releasable engagement carried on one of said first and said second mast sections, the recess providing tactile indication of the angular position of the sign panel.

In another embodiment, a hand-held paddle sign for warning passing motorists, comprises a self-supporting paddle having opposed major surfaces for displaying warning information. A first mast section has a first end having a slot receiving the paddle, and an opposed second end. A coupler releasably joins the first and a second mast section end-to-end, with the coupler keyed to the first and the second mast sections. The first and the second mast sections have a tactile indication of the angular position of the sign panel.

### BRIEF DESCRIPTION OF THE DRAWINGS

In the drawings:

FIG. 1 is a schematic rear elevation view of a signal device;

FIG. 2 is a schematic front elevation view thereof;

FIG. 3 is a fragmentary cross-sectional view of a portion of the signal device of FIG. 1, taken on an enlarged scale;

FIG. 4 is a cross-sectional view, taken along the line 4 of FIG. 2, shown on an enlarged scale;

FIGS. 5 and 6 taken together are schematic perspective views showing assembly of the arrangement of FIG. 3

FIGS. 7 and 8 taken together are schematic perspective views showing an alternative assembly of the arrangement of FIG. 3;

FIGS. 9 and 10 taken together are schematic perspective views showing another alternative assembly of the arrangement of FIG. 3;

FIG. 11 is a cross-sectional view, taken along the line 11-11 of FIG. 4, shown on an enlarged scale;

FIG. 12 is a cross-sectional view, taken along the line 12-12 of FIG. 8;

FIG. 13 is a cross-sectional view, taken along the line 13-13 of FIG. 7;

FIG. 14 is a cross-sectional view, taken along the line 14-14 of FIG. 10; and

FIG. 15 is a cross-sectional view, taken along the line 15-15 of FIG. 9.

### DESCRIPTION OF THE PREFERRED EMBODIMENTS

The invention disclosed herein is, of course, susceptible of embodiment in many different forms. Shown in the drawings and described herein below in detail are preferred embodiments of the invention. It is understood, however, that the present disclosure is an exemplification of the principles of the invention and does not limit the invention to the illustrated embodiments.

For ease of description, sign equipment utilizing a display device embodying the present invention is described herein below in its usual assembled position as shown in the accompanying drawings, and terms such as upper, lower, horizontal, longitudinal, etc., may be used herein with reference to this usual position. However, the sign equipment may be manufactured, transported, sold, or used in orientations other than and described and shown herein.

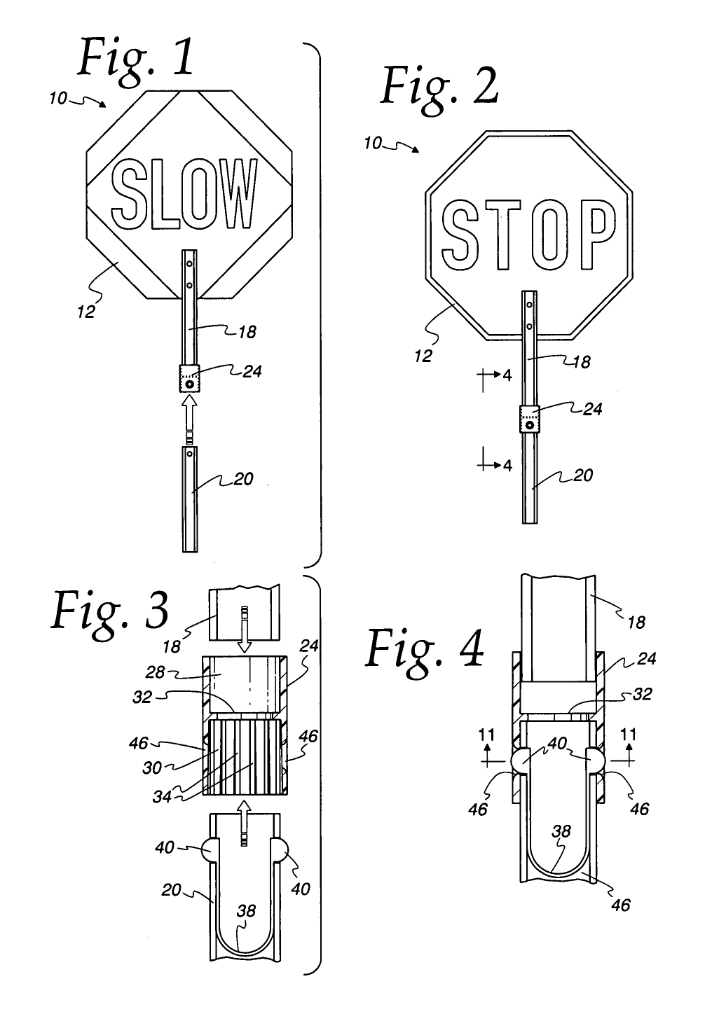

Referring to FIGS. 1 and 2, apparatus embodying the present invention provides a signal device 10 for warning oncoming motorists of a nearby conflict with a normal traffic flow, and the need to obey directions to alter traffic flow. Although the signal device can be used for a variety of purposes, it has become customary to display either a “SLOW” message as in FIG. 1, or a “STOP” message as in FIG. 2. The arrangements of FIGS. 1 and 2 preferably comprise the same signal device, rotated to one of two message indicating display positions, as shown.

One embodiment of the signal device 10 comprises a sign panel 12, which is sufficiently rigid so as to be self supporting. In one example, the message indicia is inked, painted, or otherwise affixed to a self supporting backer board. In another example, not shown, the message indicia are displayed on flexible sign panel material and are supported by a suitable frame. The sign panel 12 is supported by first and second mast sections 18, 20 joined by a coupler 24. The first mast section 18 is secured to the bottom end of sign panel 12 by rivets, threaded fasteners or other suitable securement arrangements. The mast sections 18, 20 may be made of any suitable material such as aluminum, wood, or fiber-reinforced resin, but are preferably formed of plastic material that is formed to have certain desirable features as will be described herein. The coupler 24 is made of suitable material as may be desired, but is also preferably formed of plastic.

Referring to FIGS. 3-6, the mast sections 18, 20 are telescopically inserted into opposed ends of coupler 24, which joins the mast sections end-to-end. Referring to FIG. 3, coupler 20 has opposed socket portions 28, 30 divided by divider wall 32 that limits insertion of the mast sections into the sockets. If desired, the mast sections 18, 20 can be permanently joined to coupler 24 by adhesive or sonic welding, for example, but preferably, only mast section 18 is secured in this manner. Although both mast sections 18, 20 can be removably fitted to coupler 24, it is generally preferred that only the bottom mast section 20 is joined in this fashion, to allow easy takedown of the signal device for compact storage. Preferably, lower socket is provided with splines 34 to aid in the withdrawal of the upper end of mast section 20 from socket 30. If desired, the bottom mast section 20 and, optionally, coupler 24 can be omitted if only a hand-held signal device is desired. Alternatively, mast section 20 and coupler 24 can be omitted, with upper mast section 18 being made to any length desired. Despite these possibilities, it is generally preferred to supply the signal device in the manner illustrated in FIGS. 1 and 2, to allow an operator the option of either hand holding the upper mast section 18 or other elevated support surface, or using the lower mast section 20 to support the sign panel from the ground.

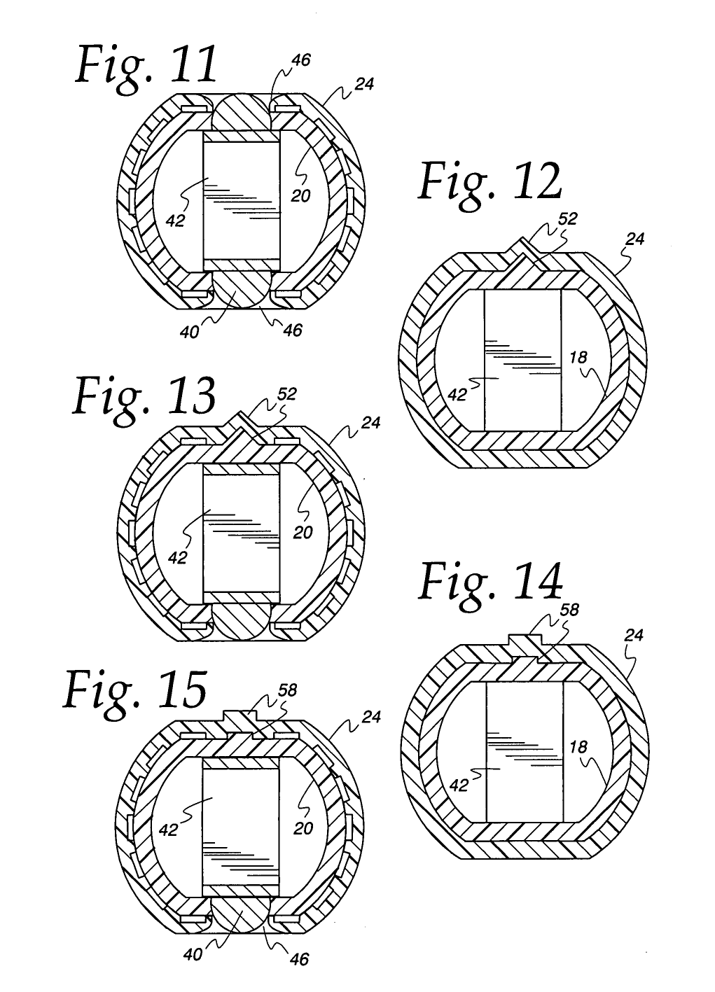

With reference to FIGS. 4-6, mast section 20 is preferably releasably secured to coupler 24 by telescopic insertion in socket 30, as mentioned. Preferably some arrangement is made to secure the connection since it may be desirable to lift the signal device from its upper end. Although a variety of releasable retention mechanisms such as hitch pins or the like can be used, it is generally preferred to provide the lower mast section 20 with a spring biased catch assembly 38 in the manner shown in FIGS. 4-6. As shown, catch members 40 are secured to ends of a flat spring 42. Although two catch members are shown, only one catch member is needed at a minimum, and the other catch member can be omitted it desired in the manner shown in FIGS. 13 and 15. When two catches are desired, the arrangement of FIGS. 3-6 and 11 can be used, with coupler 24 being provided with a pair of opposed holes 46 for receiving the catches 40.

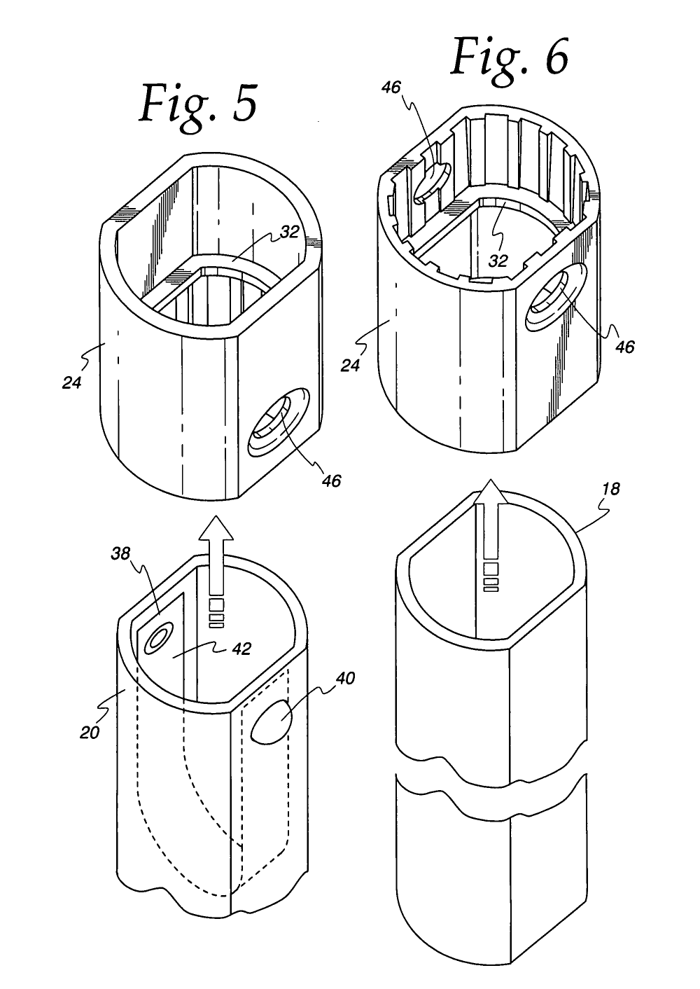

As can be seen for example in FIGS. 5 and 6, it is generally preferred that the mast sections have a nonuniform outer surface, preferably one that has a discontinuous shape. As shown, the mast sections have alternating outer rounded and flattened surfaces. Other different shapes can also be used, such as triangular, hexagonal and multi-faceted shapes having regular or irregular, non repeating cross-sections. As indicated in FIGS. 1 and 2, the flattened surfaces are aligned with the major faces of sign panel 12, thus providing a length-wise continuous tactile indication of sign panel position. If desired, additional tactile indication can be provided, such as removing one of the catches 40. Also, by removing one of the catches 40 and by careful permanent securement of upper mast section 18 to coupler 24, a further tactile indication of sign panel position, one indicating which of the two surfaces is facing traffic, is provided.

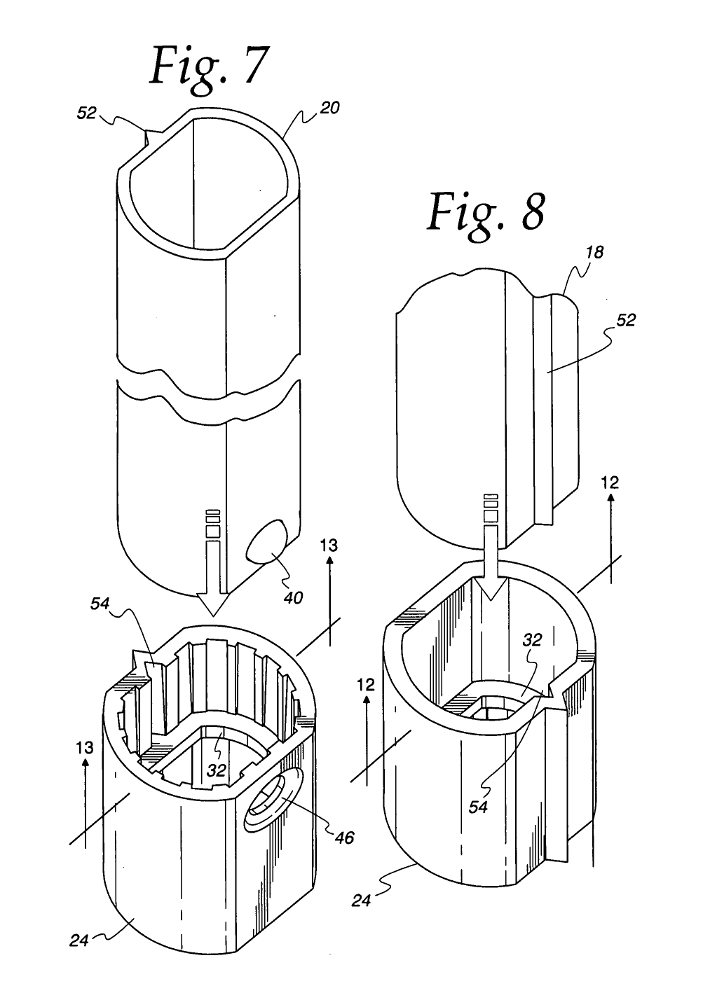

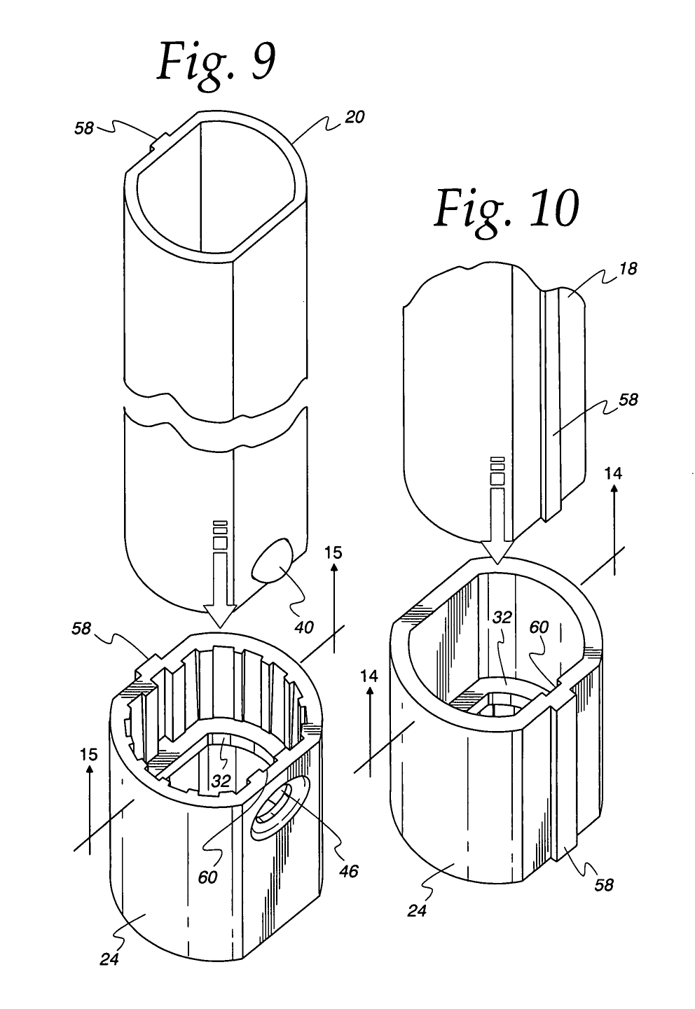

Referring now to FIGS. 7 and 8, an outer protrusion 52 of generally triangular cross-sectional shape is added to the outer surfaces of mast sections 18, 20. A complementary recess 54 is provided in coupler 24 to receive the position-indicating protrusion 52. As shown, the additional tactile indication of protrusion 52 is provided continuously along the length of each mast section. If desired, the protrusion can be omitted from one of the mast sections, such as the lower mast section 20. In FIGS. 9 and 10, the outer protrusion 58 and a complementary shaped recess 60 of rectangular cross-section are provided.

The foregoing descriptions and the accompanying drawings are illustrative of the present invention. Still other variations and arrangements of parts are possible without departing from the spirit and scope of this invention.

What is claimed is:

1. A hand-held display device for warning passing motorists, comprising:
a self-supporting sign panel having opposed major surfaces for displaying warning information;
a first mast section with a first end receiving the sign panel for engagement therewith and an opposed second end;
a second mast section;
a coupler releasably joining the first and the second mast sections end-to-end;
the coupler keyed to the first and the second mast sections; and
at least one of the first and the second mast sections having a tactile indication of the angular position of the sign panel.

2. The display device according to claim 1 wherein the first and the second mast sections have an outer surface with alternating rounded and flattened portions indicative of the angular position of the sign panel.

3. The display device according to claim 2 wherein the coupler has first and second opposed sockets for receiving ends of the first and the second mast sections.

4. The display device according to claim 3 wherein the coupler is permanently fixed to one mast section and releasably connected to the other mast section.

5. The display device according to claim 3 wherein the coupler is permanently fixed to the first mast section and releasably connected to the second mast section.

6. The display device according to claim 5 wherein the socket releasably connected to the second mast section has internal splines engaging the second mast section.

7. The display device according to claim 3 wherein the coupler includes an insertion limiting divider wall between the first and the second sockets.

8. The display device according to claim 1 wherein the first and the second mast sections and the coupler have interfitting keying structures.

9. The display device according to claim 8 wherein the keying structures of the first and the second mast sections comprise outwardly protruding structures received in cooperating recesses in the socket.

10. The display device according to claim 9 wherein the keying structure on at least one of the first and the second mast sections is formed parallel to a longitudinal axis thereof, to provide tactile indication of the angular position of the sign panel.

11. The display device according to claim 1 wherein the keying structure has a generally triangular cross-sectional shape.

12. The display device according to claim 1 wherein the keying structure has a generally rectangular cross-sectional shape.

13. The display device according to claim 1 wherein the coupler includes a recess receiving a releasable engagement carried on one of said first and said second mast sections, the recess providing tactile indication of the angular position of the sign panel.

14. A hand-held paddle sign for warning passing motorists, comprising:
a self-supporting paddle having opposed major surfaces for displaying warning information;
a first mast section with a first end having a slot receiving the paddle, and an opposed second end;
a second mast section;
a coupler releasably joining the first and the second mast sections end-to-end;
the coupler keyed to the first and the second mast sections; and
at least one of the first and the second mast sections having a tactile indication of the angular position of the sign panel.
